(19) United States
(12) Patent Application Publication
(10) Pub. No.: US 2010/0100214 A1
(43) Pub. Date: Apr. 22, 2010

(54) CUSTOM-DESIGNED PRINTED OFFICE PRODUCTS AND RELATED METHOD

(75) Inventor: Darren MacDonald, Costa Mesa, CA (US)

Correspondence Address: AVERY DENNISON CORPORATION;Patent Group, Law Department - 3 South, P.O. BOX 7090, PASADENA, CA, 91109-7090, US

(73) Assignee: Avery Dennison Corporation

(21) Appl. No.: 12/422,976

(22) Filed: Apr. 13, 2009

Related U.S. Application Data
(63) Continuation-in-part of application No. 12/255,630, filed on Oct. 21, 2008.

(51) Int. Cl. G06F 17/50

(52) U.S. Cl. 700/97

(57) ABSTRACT

A software application that can be downloaded from a server and execute within the web browser of an electronically linked computer is programmed to include advanced editing tools that assist in the interactive design of a print file used to customize a printable office product. For example, the software application includes a text merge tool that enables each text element in the print file to be merged with a corresponding set of variable data using a series of highly intuitive graphical user interfaces. One graphical user interface includes a workspace for the print file and at least one data field button identifying a particular category of variable data that can be bound with a corresponding text element displayed on the workspace. Using the text merge tool, each printable office product produced in conjunction with a custom print order can be personalized with individual-specific data.

### CROSS-REFERENCE TO RELATED APPLICATION

The present application is a continuation-in-part of U.S. patent application Ser. No. 12/255,630, filed Oct. 21, 2008 in the name of Darren MacDonald, the disclosure of which is incorporated herein by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

The present invention relates generally to the custom design of printed office products, such as binders, dividers and the like, and more particularly to the interactive custom design of printed office products via the Internet.

Avery Dennison Corporation of Pasadena, Calif. is a worldwide leader in the manufacture and sale of printable office products, such as binders, dividers and the like. To enhance their appearance, certain printable office products are often mass produced in a plurality of stock colors and patterns.

It has been found that, in certain instances, consumers wish to enhance the aesthetics of a set of office products by printing common design elements on one or more surfaces of each product. Specifically, it is well known in the art for a set of office products to be custom printed to include, inter alia, (i) a common background design or pattern, (ii) one or more pictures, images and/or clipart, and (iii) names, dates and/or other relevant text. For example, the front cover of each three-ring binder to be disseminated at a corporate seminar may be commonly printed with, among other things, the name of the company, the date of the seminar, the title of a discussion at the seminar and a full color, photo quality image relating to the seminar subject matter.

Traditionally, a print order for the custom design of printed office products is placed by a customer with a sales representative for the product manufacturer. Using the information provided by the customer to the sales representative, the manufacturer generates an electronic print file for the custom design. In certain instances, the manufacturer may generate a sample for the customer to review prior to printing to ensure satisfaction. If necessary, the customer may request modifications to the custom design, which are then incorporated into the print file by the manufacturer. The aforementioned review process is often repeated, as deemed necessary, until the customer is satisfied with the finished product.

Once the sample is accepted by the customer, the product manufacturer electronically transmits the print file to an affiliated print facility, which, in turn, prints the custom design on the specified office products. Upon completion of the printing process, the printed office products are then shipped to the customer in a timely manner, thereby completing execution of the order.

However, the aforementioned process for generating customized printed office products suffers from a few notable drawbacks.

As a first drawback, the manufacturer is required to staff a multitude of employees who are responsible for, among other things, fielding custom print requests and, in turn, creating an electronic print file in accordance with the request. As can be appreciated, this staffing requirement significantly increases manufacturer operating expenses, which is highly undesirable.

As a second drawback, in those circumstances in which a customer is not provided with the opportunity to review an accurate sample, the product manufacturer runs the risk that the customer will ultimately be dissatisfied with the finished product upon receipt. Consequently, if the customer is dissatisfied with the finished product, a modification of the print file and a subsequent re-execution of the entire print order is often required, thereby significantly increasing the overall printing costs, which is highly undesirable.

As a third drawback, in those circumstances in which the customer is provided with both a sample and the ability to request modifications, the overall process is rendered unduly time-consuming and expensive in nature, which is highly undesirable.

As a fourth drawback, manufacturers have costs associated with customization of printed office products that ultimately increases the costs to customers. The increased costs to customers can be in the form of minimum purchase requirements, which are often larger amounts of the product than the customer actually needs, or in the form of “set-up” costs, which cover the cost for the generation of digital artwork or making print plates and the additional proofing required. Frequently, manufacturers will require both.

In response to the aforementioned shortcomings, certain manufacturers in the office products retail industry have recently developed means for enabling customers to interactively design the electronic file used by a print facility to print products in accordance with an order. Specifically, an Internet-accessible server that is maintained by the manufacturer is provided with an editing program that can be downloaded by and to a customer computer via the Internet, the editing program preferably running within a conventional Internet browser program on the customer computer. In this manner, the customer is able to retrieve, examine, and dynamically modify the print file stored on the manufacturer server prior to execution of the print order. By enabling the customer to directly partake in the design of the print file, the aforementioned online design system results in (i) a reduction in operating expenses, (ii) a greater likelihood of customer satisfaction, and (iii) an improvement in the speed of the overall process, all of which are highly desirable.

Although widely used in the art, the interactive custom design of a set of printable office products presently suffers from a few notable shortcomings.

As a first shortcoming, the editing programs utilized in the web-based design of a set of printed office products fail to offer customers with a simplified means for personalizing each product in the set. Specifically, the print file generated using present editing programs is traditionally used by a print facility to mass produce a set of office products that have been custom designed in an identical fashion (i.e., each office product is printed with the same set of design elements). The editing programs presently provide no simplified means for manipulating the file to allow for the personalization of each item in the set. For example, the print file used to generate a set of custom-designed binders to be disseminated at a corporate seminar can not be readily modified to additionally include personalized information (e.g., the name of each attendee at the seminar).

As a second shortcoming, the editing programs utilized in the web-based design of a set of printed office products presently offer consumers with limited tools for interactively modifying custom print files. As a result, the present process in which a consumer interactively edits a custom print design has been found to be both inadequate and time-consuming.

As a third shortcoming, the editing programs utilized in the web-based design of a set of printed office products often fail to accurately depict how the finished product will appear. Specifically, because a relatively small-sized, two-dimensional computer screen is used to display a relatively large, three-dimensional object, consumers are often insufficiently apprised of how the finished product will appear.

Consumers may have alternatives to manufacturer-implemented customization of printed office products. For example, a consumer can insert a customized sheet of paper into a clear cover pocket of a binder in an effort to customize a binder, thereby avoiding the drawbacks and shortcomings described above. However, the appearance of the binder has less of a professional appearance than a binder customized by the manufacturer, and thus, having the cover pockets with inserted sheets of paper is generally less preferred.

### SUMMARY

As one feature of the present invention, there is provided a method of creating at least one electronic print file used in the customized design of at least one printable office product. The method uses a software application. The software application provides a design file that is formatted for each of the at least one printable office product and design file includes a first text element. At least one variable datum is input using the software application. The at least one variable datum is included in a first data field. Using the design file, the first data field and the first text element are merged to yield at least one individualized print file.

As another feature of the present invention, there is provided a method of the type as described above wherein, in the input step, the at least one variable datum is input into the software application by importing a dataset file from an external source.

As another feature of the present invention, there is provided a method of the type as described above wherein, in the input step, the at least one variable datum is created within the software application.

As another feature of the present invention, there is provided a method of the type as described above wherein, in the input step, the software application displays the at least one variable datum within a data grid.

As another feature of the present invention, there is provided a method of the type as described above wherein the at least one variable datum displayed within the data grid is modifiable.

As another feature of the present invention, there is provided a method of the type as described above wherein the data grid is arranged into at least one column and at least one row, each column being designated for a particular data field and each row being designated for a particular record.

As another feature of the present invention, there is provided a method of the type as described above wherein the number of rows displayed in the data grid is modifiable.

As another feature of the present invention, there is provided a method of the type as described above wherein, in the merging step, the software application generates a graphical user interface to facilitate merging the first data field with the first text element.

As another feature of the present invention, there is provided a method of the type as described above wherein the graphical user interface includes (a) a workspace displaying the design file with the first text element, and (b) a first data field button corresponding to the first data field.

As another feature of the present invention, there is provided a method of the type as described above wherein, in the merging step, the at least one variable datum associated with the first data field is bound to the first text element in the workspace.

As another feature of the present invention, there is provided a method of the type as described above wherein, after being bound, the first data field button and the first text element are each provided with a common graphical marking.

As another feature of the present invention, there is provided a method of the type as described above wherein, the common graphical marking is color-coded.

As another feature of the present invention, there is provided a method of the type as described above wherein the graphical user interface further includes a second data field button corresponding to a second data field in the at least one variable datum, the second data field button being displayed with a different graphical marking than the first data field button.

As another feature of the present invention, there is provided a method of the type as described above further including the step of, after the merging step, reviewing the at least one individualized print file.

As another feature of the present invention, there is provided a method of the type as described above wherein, in the review step, the at least one individualized print file is represented in a graphical user interface as a thumbnail image displaying the at least one variable datum.

As another feature of the present invention, there is provided a method of the type as described above wherein the thumbnail image is viewable within the graphical user interface as an enlarged three-dimensional rendering.

As another feature of the present invention, there is provided a method of manufacturing at least one printable office product, the method implemented using a software application. The method includes the steps of (a) providing a design file that is formatted for the at least one printable office product, and the design file including a first text element, (b) inputting at least one variable datum into the software application, and the at least one variable datum is included in a first data field, and (c) using the design file and merging the first data field with the first text element to yield at least one individualized print file.

As another feature of the present invention, there is provided a method of the type as described above further including the step of, after the merging step, printing at least one individualized print file on a corresponding at least one printable office product.

As another feature of the present invention, there is provided a system for the custom design of at least one printed office product, the system including (a) a server including a computer-readable medium, and (b) at least one computer electronically linked with the server, (c) wherein a software application is stored on the computer-readable medium. The software application is downloadable to the at least one computer. The software application generating at least one electronic print file to be used in the customized design of at least one printable office product. The software application being designed to provide a design file that is formatted for at least one printable office product. The design file including a first text element. The software application also being designed to receive at least one variable datum, and the at least one variable datum is included in a first data field. The software application further being designed to use the design file and to merge the first data field with the first text element to yield at least one individualized print.

As another feature of the present invention, there is provided a system of the type as described above wherein the downloadable software application is configured to run within a browser application on the at least one customer computer.

Various other features and advantages will appear from the description to follow. In the description, reference is made to the accompanying drawings that form a part thereof, and, in which, is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of a system for the online custom design of printed office products, the system being configured according to the teachings of the present invention;

FIGS. 2(a)-(j) are a series of sample screen displays for a software application designed for use in connection with the system of FIG. 1, the software application being designed according to the teachings of the present invention, and the software application enabling a customer to interactively design an electronic print file that can be used to customize a printable office product;

FIGS. 3(a)-(b) are a pair of sample screen displays for the software application of FIG. 2(a), the sample screen displays being useful in understanding a panel selection tool that operates as part of the software application; and

FIGS. 4(a)-(n) are a series of sample screen displays for the software application of FIG. 2(a), the sample screen displays being useful in understanding a text merge tool that operates as part of the software application.

### DETAILED DESCRIPTION

### System for Online Custom Design of Printed Office Products

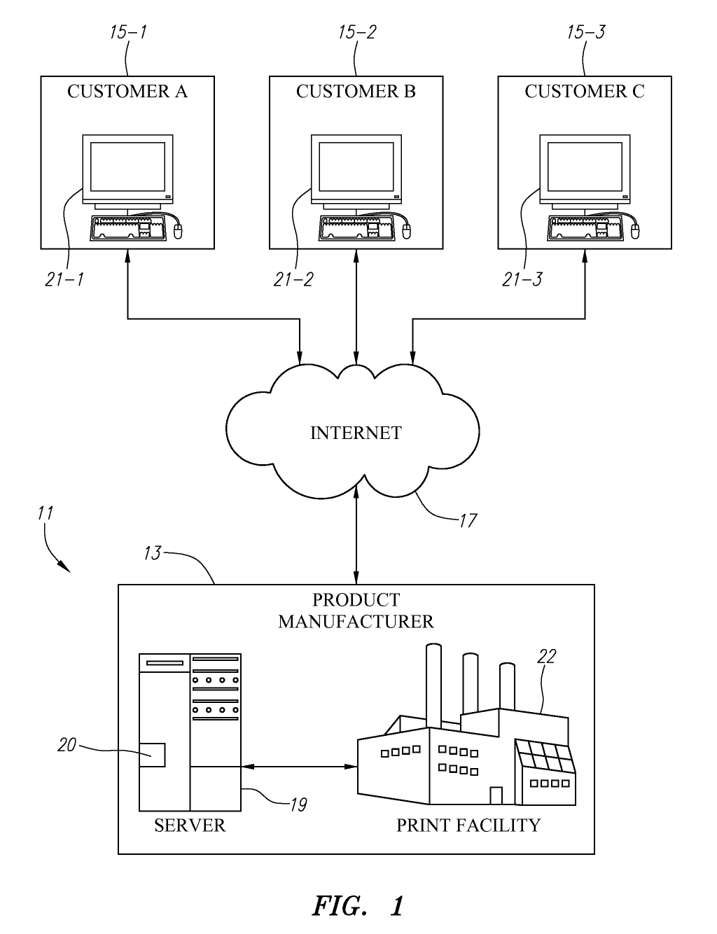

Referring now to FIG. 1, there is shown a simplified block diagram of a system for the online custom design of printed office products, the system being configured according to the teachings of the present invention and identified generally by reference numeral 11. As defined herein, use of the term “printed office products” denotes any office product on which a customized design can be printed. Examples of printed office products include binders, dividers, cards, business cards, greeting cards, postcards, labels, and the like. For purposes of simplicity only, the system and method of the present invention will be shown herein in connection with the customized design of a three-ring binder. However, it should be noted that the present invention is not limited to the custom design of binders. Rather, it is to be understood that the present invention could be similarly utilized in conjunction with the design of alternative types of printable office products, such as dividers, cards, business cards, greeting cards, postcards, labels, and the like, without departing from the spirit of the present invention.

As can be seen, system 11 enables a single manufacturer of printable office products 13 to be electronically linked with a plurality of independent customers (also referred to as users) 15-1, 15-2, and 15-3 via the Internet 17. As defined herein, the term “plurality” means two or more. Specifically, manufacturer 13 either directly or remotely maintains a centralized server 19, which can be accessed through the Internet 17. In addition, customers 15-1, 15-2 and 15-3 (also identified herein as Customer A, Customer B and Customer C, respectively) are provided with web-enabled computers 21-1, 21-2, and 21-3, respectively. In this manner, each customer 15 is able to access server 19 via the Internet 17.

As will be described in detail below, the present invention enables each customer 15 to create a customized print file that is directed by server 19 to an affiliated print facility 22. Using the customized print file, print facility 22 customizes office products in compliance with a designated print order. Alternatively, the print facility 22 and the server 19 need not be affiliated with one another.

### Overview of the Present Method of Online Custom Design

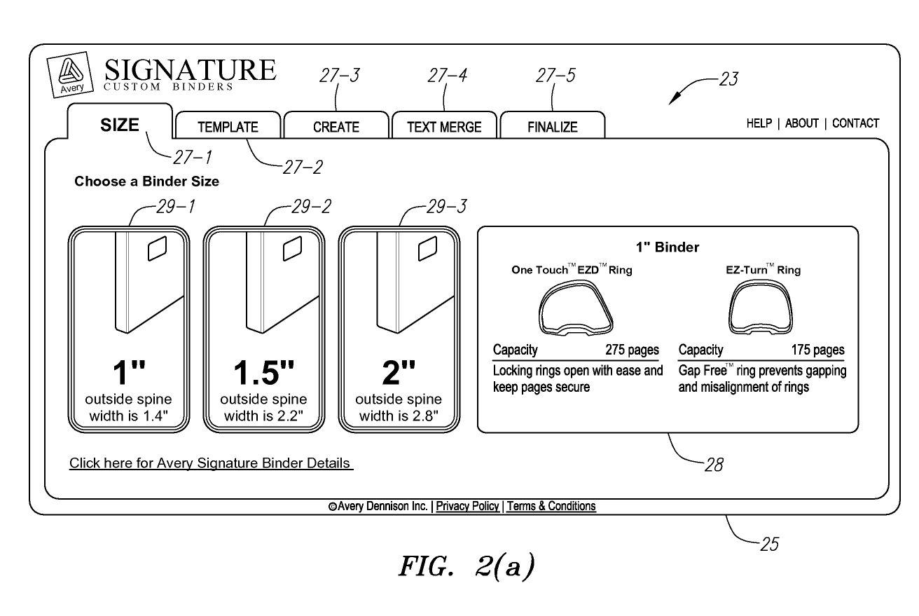

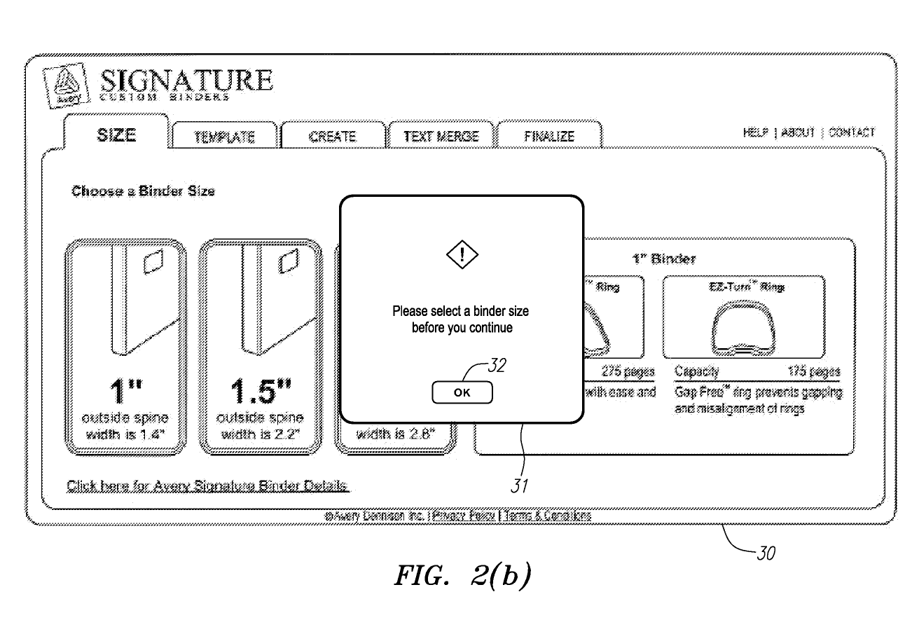

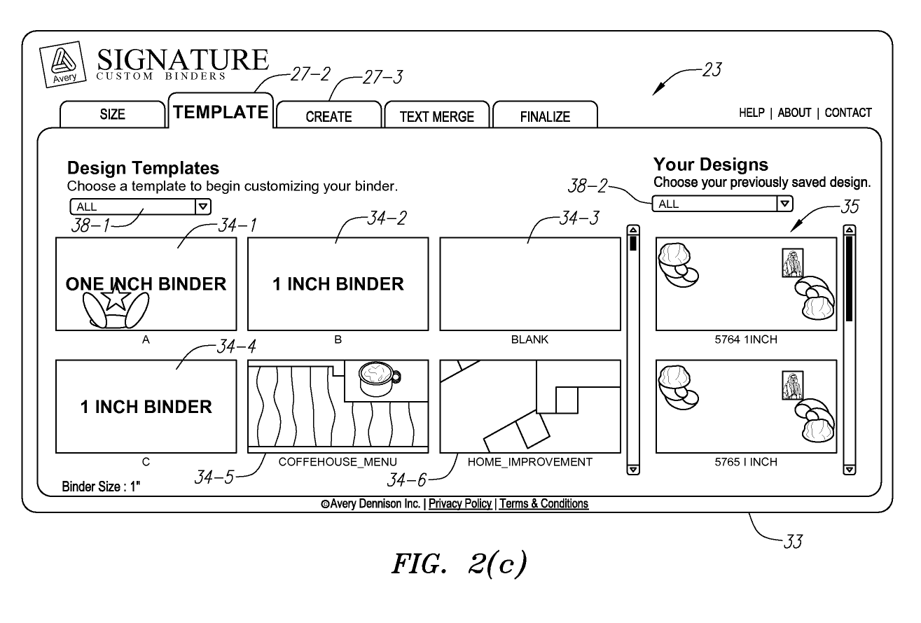

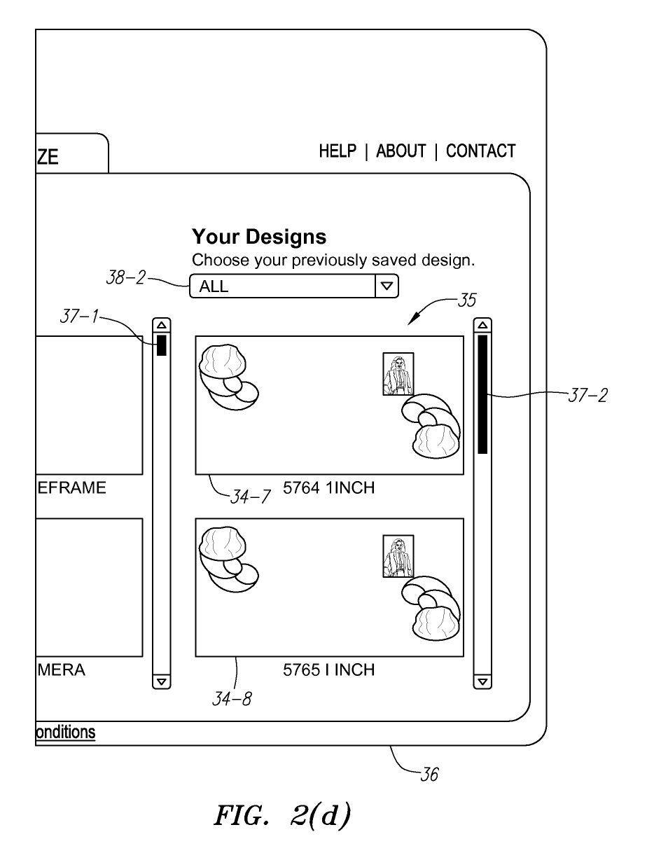

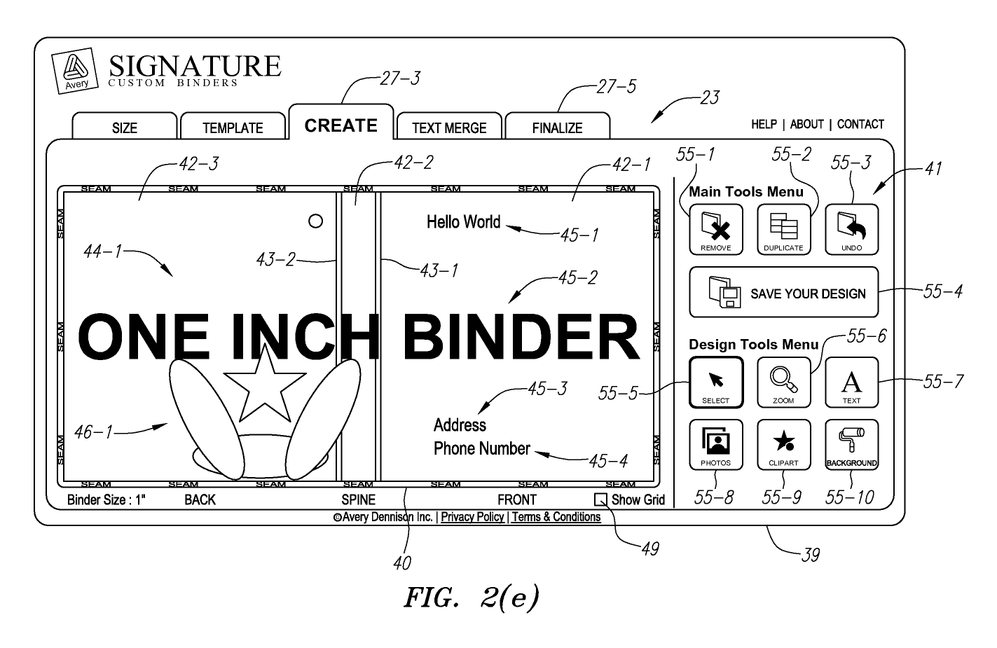

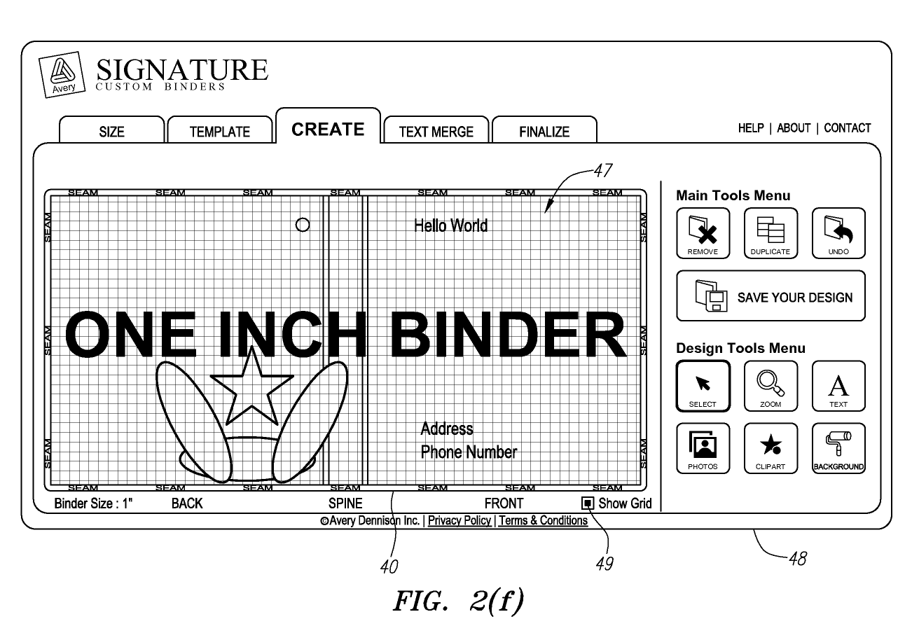

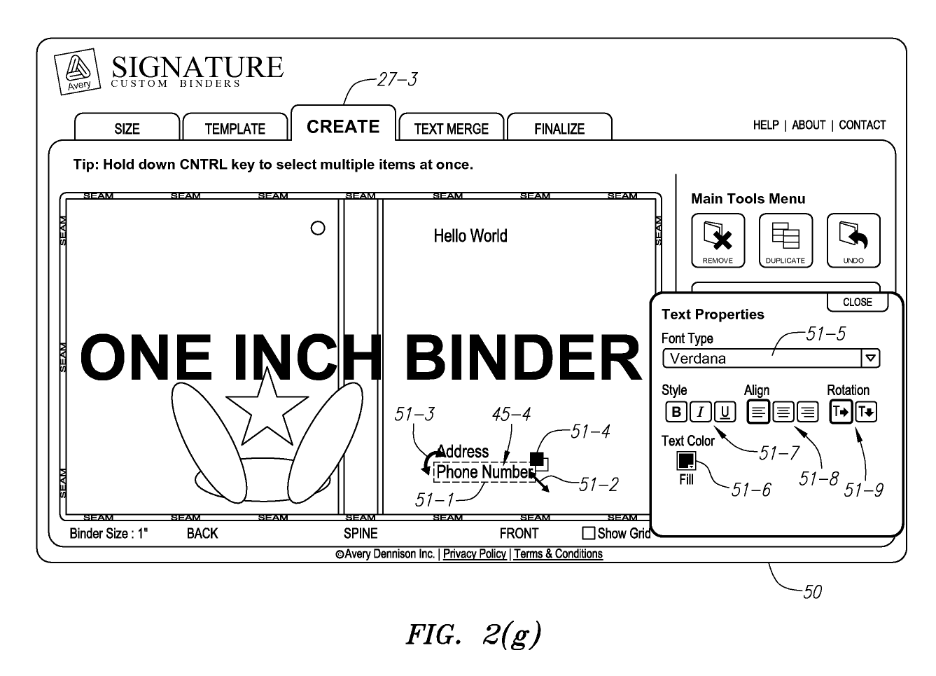

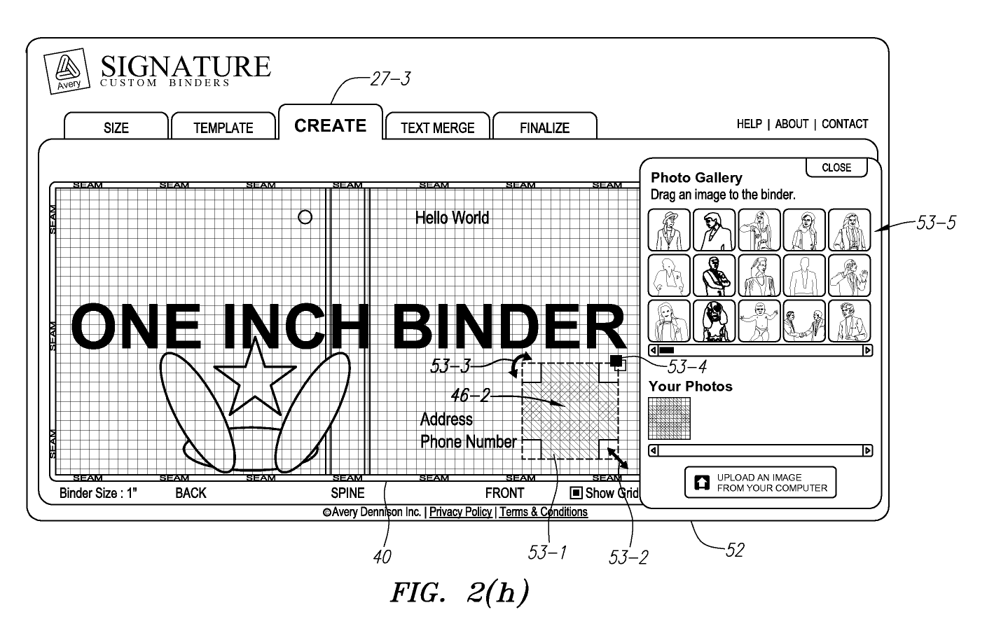

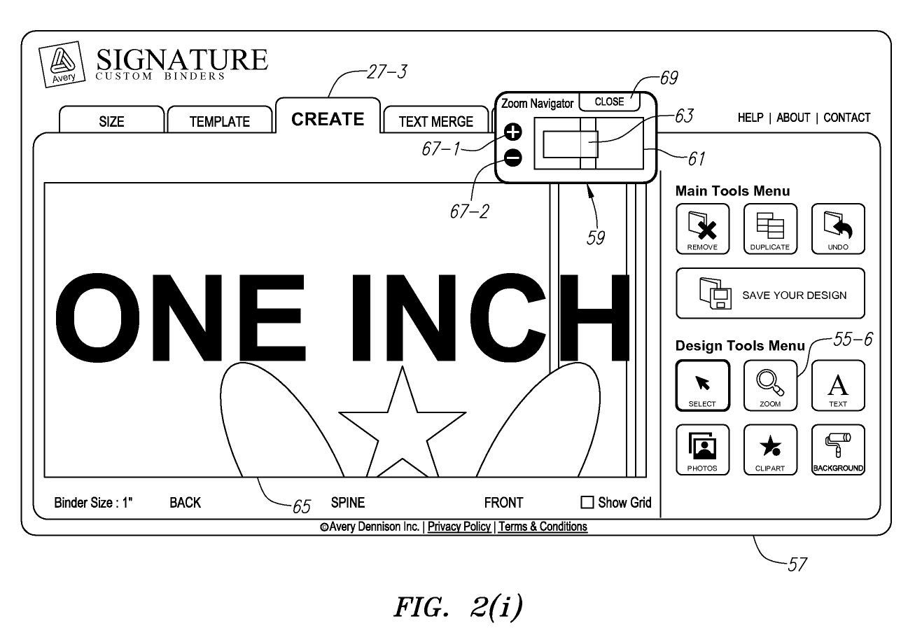

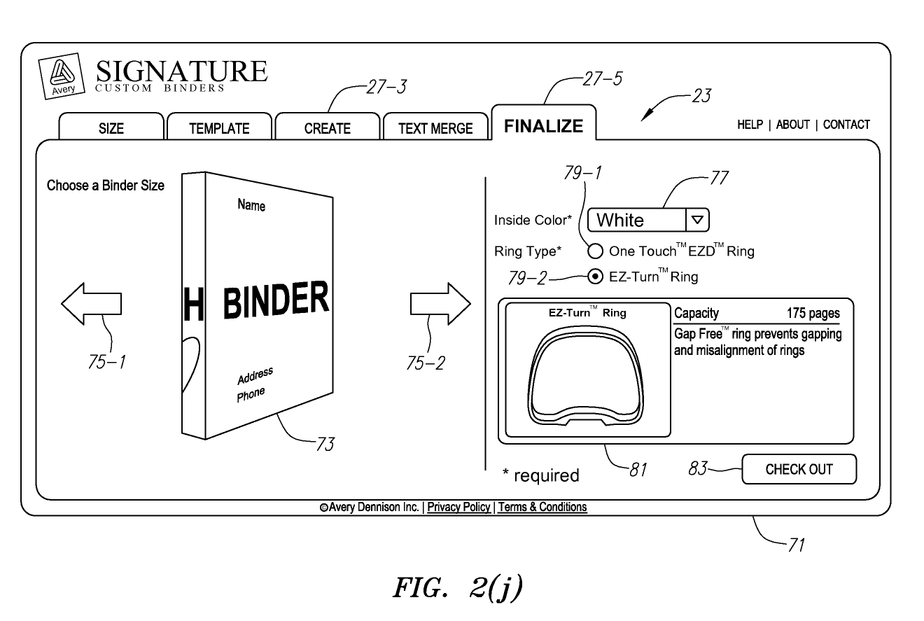

Referring additionally to FIG. 2(a), a novel software application that can be used to create a customized print file for printed office products is stored in a computer-readable medium 20 within server 19, the software application being designed according to the teachings of the present invention and identified generally by reference numeral 23. As defined herein, computer-readable medium 20 represents any nonvolatile storage device (e.g., an internal or external magnetic hard drive, CD or DVD disks, flash memory, RAM or ROM, optical drive, magnetic tape device, etc.) that is electronically coupled to, or included in, server 19.

Preferably, the software application 23 is capable of being downloaded from server 19 by and to a customer computer 21 through the Internet 17. For example, the software application 23 may be coded in a particular multimedia authoring program (e.g., ADOBE FLASH Player, MICROSOFT SILVERLIGHT, JAVAFX by SUN Microsystems, etc.) that is downloaded and runs within a conventional web browser application on a customer computer 21. ADOBE and FLASH are registered trademarks of Adobe Systems, Inc. of San Jose, Calif. MICROSOFT and SILVERLIGHT are trademarks of Microsoft Corporation of Redmond, Wash. JAVAFX and SUN are registered trademarks of Sun Microsystems, Inc. of Santa Clara, Calif. Alternatively, the software application can be supplied as a stand-alone application that is stored on the customer computer 21 on a computer-readable medium.

Referring now to FIGS. 2(a)-(j), there is shown a series of sample screen displays for the software application 23 that are useful in understanding the general process by which application 23 enables a customer 15 to create an electronic print file, which is, in turn, utilized by print facility 22 to customize the design of a set of printable office products.

Upon initialization of application 23 by the customer 15, the sample screen display shown in FIG. 2(a) is presented on the screen of the customer computer 21, the screen display being identified generally by reference numeral 25. As can be seen, the software application 23 includes a plurality of task-based functionality tabs 27-1 through 27-5, which are layered, or stacked, so that the contents of at most one tab 27 are viewable at a time. More specifically, the software application 23 includes a size tab 27-1, a template tab 27-2, a create tab 27-3, a text merge tab 27-4 and a finalize tab 27-5. It should be noted that tabs 27 are layered, left to right, to replicate the preferred sequence of the custom design process. As can be seen, the size tab 27-1 is opened upon initialization of application 23.

It should be noted that software application 23 is not limited to the array of tabs 27 shown herein. Rather, it is to be understood that additional task-based functionality tabs could be incorporated into software application 23 without departing from the spirit of the present invention. For example, software application 23 could be designed to include an additional functionality tab that enables the user to, among other things, choose between various types of printable office products to be custom designed.

With the size tab 27-1 opened, the user is required to select a binder size for the custom order. To assist in the selection process, three binder size selection buttons 29-1, 29-2, and 29-3 are prominently arranged in a side-by-side relationship, button 29-1 displaying a 1 inch binder, button 29-2 displaying a 1.5 inch binder and button 29-3 displaying a 2 inch binder. In addition, an enlarged binder clip window 28 is provided beside buttons 29, window 28 displaying a pair of different binder ring styles that are available for selection. As can be seen, for each available binder ring, window 28 displays (i) the name commonly associated with the ring in commerce, (ii) a side view depiction of the ring, (iii) the paper capacity of the ring in conjunction with a particular binder size (the 1 inch binder size serving as the default size) and (iv) a brief promotional description of the ring.

As the user moves the cursor directly over each binder size button 29, the periphery of the particular binder size button 29 changes, e.g., changes color. At the same time, if either button 29-2 or 29-3 is highlighted in this manner, binder clip window 28 instantly reflects the change in binder size and accordingly modifies the paper capacity information provided. In this manner, the consumer can make an informed decision regarding the binder size and ring style to be used in the order. To select a particular binder size, the user clicks directly on the desired button 29. In turn, the software application 23 creates an active design file and opens template tab 27-2.

As shown in the sample screen display 30 provided in FIG. 2(b), if the user attempts to bypass the binder size selection process (e.g., by clicking on tabs 27-2 through 27-5) without selecting a binder size button 29, a pop-up window 31 is prominently displayed that informs the user to first select a binder size. This ensures that the custom print file is appropriately formatted to the proper binder size.

It should be noted that with pop-up window 31 displayed in the foreground, the remaining visual elements, which are displayed in the background of screen display 30, appear slightly out of focus, or blurred, to draw the attention of the user to pop-up window 31. Once pop-up window 31 has been observed by the user, activation of an OK button 32 returns the user to open tab 27-1.

Referring now to FIG. 2(c), there is shown a sample screen display 33 with template tab 27-2 opened. As can be seen, the user is able to select any one of an array of pre-designed templates 34 that are properly formatted for the selected binder size, templates 34-1 through 34-6 being shown herein. As will be described further in detail below, each template 34 includes a predefined arrangement of background, text, and/or image-related elements, thereby providing the user with a professional-looking starting point from which to create a printable design.

Personalized templates that have been created and saved by the user are similarly provided for selection by the user within a previously saved template panel 35 that is provided under the heading “Your Designs” in sample screen display 33. In FIG. 2(d), there is provided an enlarged, fragmentary sample screen display 36 that shows a pair of previously saved templates 34-7 and 34-8 displayed within panel 35.

As seen most clearly in FIG. 2(d), a pair of vertical scroll bars 37-1 and 37-2 is provided to assist in reviewing available templates 34. In addition, as seen most clearly in FIG. 2(c), a pair of drop down windows 38-1 and 38-2 is provided that groups the various templates 34 into selected categories (e.g., business, general, industry, IT, kitchen, medical, restaurant, school). To select a particular template 34, the user clicks directly on the template image. In turn, the software application 23 applies the parameters of the selected template to the active design file. In turn, application 23 opens create tab 27-3 and displays the active file for editing purposes.

Referring now to FIG. 2(e), there is shown a sample screen display 39 for an active file created using template 34-1, the active file being shown with create tab 27-3 opened for editing purposes. As can be seen, create tab 27-3 includes an active workspace 40 and a tools menu 41.

The workspace 40 provides an enlarged, two-dimensional representation of the active design file as it will appear when printed on the intended office product. In the present example, the active design file is shown formatted for printing on a 1 inch three ring binder.

As can be seen, the software application 23 formats the active workspace 40 into a plurality of discrete panels 42, with adjacent panels 42 being separated by vertical partition lines 43. It is to be understood that each panel 42 represents a particular printable surface on the designated office product. For example, in connection with the design of the 1 inch binder shown herein, the workspace 40 is formatted to include a front panel 42-1, a spine panel 42-2 and a back panel 42-3, with the front panel 42-1 and the spine panel 42-2 being separated by a first partition line 43-1 and the spine panel 42-2 and the back panel 42-3 being separated by a second partition line 43-2. In this manner, the user can view the entirety of the active file.

In the present example, partition lines 43 are visibly displayed on the active workspace 40. However, it is to be understood that partition lines 43 could be functionally active but visibly hidden on the workspace 40 without departing from the spirit of the present invention.

The software application (also referred to as a program) 23 is designed such that the active file displayed in the workspace 40 is capable of supporting a variety of different visual elements that can be modified and/or repositioned at any location in the workspace 40. As defined herein, “visual elements” encompasses (i) a background element 44, which may be in the form of an intricate, multi-colored background design or pattern; (ii) one or more text elements 45, which can be used, inter alia, to identify the subject matter of the office product; and (iii) one or more image elements 46 (e.g., photographs, clip art or other similar images), which may be in the form of, inter alia, a high-quality, full-color photograph relevant to the subject matter of the product. Together, the ability to select, modify, and arrange the visual elements on workspace 40 allows for the production of a detailed, professional-style custom design.

For example, the active file displayed in the workspace 40 shown in FIG. 2(e) includes a blank background element 44-1, a plurality of text elements 45-1, 45-2, 45-3 and 45-4, and an image element 46-1.

It should be noted that a grid 47 can be selectively applied to workspace 40 to assist in the arrangement of the visual elements for the active file, as shown in the sample screen display 48 provided in FIG. 2(f). Both the activation and deactivation of the grid are accomplished by clicking on a grid box 49.

Referring now to FIG. 2(g), there is shown a sample screen display 50 in which text element 45-4 has been selected with create tab 27-3 opened. As can be seen, by clicking directly on the particular text element 45-4, a visible text box 51-1 appears around the text element 45-4 along with a pop-up of various text-related controls that assist in the modification of the activated text element 45-4. Examples of preferred text-related controls include, but are not limited to, a text box resizing tool 51-2, a text box rotation tool 51-3, a text box order tool 51-4 (i.e., for moving the text box forward or backward in relation to other elements), a font type pull-down window 51-5 for changing the font of the text, a text color icon 51-6 for activating a palette for changing the text color, text style tools 51-7 (e.g., bold, italic and underline), text alignment tools 51-8 (e.g., left, right and center) and text orientation tools 51-9 (e.g., vertical or horizontal).

Similarly, it should be noted that by clicking directly on an image element 46 on workspace 40, a visible picture box appears around the image element 46 along with a pop-up of various image-related controls that assist in the modification of the activated image element 46. Specifically, referring now to FIG. 2(h), there is shown a sample screen display 52 in which an image element 46-2 on workspace 40 has been selected for editing purposes. As can be seen, upon selection of image element 46-2, a picture box 53-1 appears around image element 46-2 along with an image resizing tool 53-2, an image rotation tool 53-3 and an image order tool 53-4 (i.e., for moving the image box forward or backward in relation to other elements). The photo gallery tool 53-5 is present along with the image-related controls when the image is initially added to workspace 40. Additionally, it should be noted that the aforementioned image-related controls can be configured to act upon an entire image, or only portions of an image, in particular, portions of an image within a selected panel. For example, the portion of an image in a selected panel can be converted to black and white, while the portion of the image not in the selected panel is in color.

Referring back to FIG. 2(e), to further assist the user in the process of redesigning the active file displayed on the workspace 40, the create tab 27-3 includes a tool menu 41 having a plurality of different functionality controls 55, each functionality control 55 being preferably displayed as a user-intuitive icon. Specifically, the tools menu 41 includes: (i) a remove button 55-1 for deleting a selected text element 45 or image element 46 from the workspace 40; (ii) a duplicate button 55-2 for copying a selected text element 45 or image element 46 onto the workspace 40; (iii) an undo button 55-3 for undoing (i.e., changing back) the last edit to the active file; (iv) a save button 55-4 for saving the active file as a personally designed template on the template tab 27-2 (i.e., displayed under the “Your Designs” template panel 35 on tab 27-2); (v) a select button 55-5 for activating a cursor that can be used to select a particular text element 45 or image element 46 displayed on the workspace 40; (vi) a zoom button 55-6 for enlarging any section of the workspace 40 using a pop-up zoom navigator (described in detail below); (vii) a text button 55-7 for adding a text box to the active workspace 40; (viii) a photo button 55-8 for adding a picture to the active workspace 40; (ix) a clipart button 55-9 for adding a piece of clipart to the active workspace 40; and (x) a background button 55-10 for selecting and downloading a background to replace the active background element 44-1 on workspace 40.

Referring now to FIG. 2(i), there is shown a sample screen display 57 in which zoom button 55-6 on tool menu 41 has been selected by the user. As referenced briefly above, the selection of zoom button 55-6 on tool menu 41 activates a zoom navigator tool 59. As can be seen, zoom navigator tool 59 includes a miniaturized active workspace outline 61 (i.e., a limited-size representation of workspace 40) and a zoom window 63 that is movable within workspace outline 61. It should be noted that the portion of the active workspace that is located within zoom window 63 is represented as an enlarged workspace 65. In this manner, by clicking and dragging zoom window 63 within outline 61, the user is able to enlarge any portion of the active workspace for acute editing purposes, which is highly desirable. Zoom window size controls 67-1 and 67-2 are also provided within navigator 59 to increase and decrease, respectively, the size of zoom window 63 relative to workspace outline 61. Once satisfied with the zoom-style editing process, the user can return to the full-view representation of the active workspace (as shown in FIG. 2(e)) by activating a close button 69 on zoom navigator 59.

Referring back to FIG. 2(e), when the user is satisfied with the appearance of the binder exterior as shown with create tab 27-3 opened, the user completes the binder design process by clicking on finalize tab 27-5. Referring now to FIG. 2(j), there is shown a sample screen display 71 of the active file with finalize tab 27-5 shown open. As can be seen, program 23 creates (i) a three-dimensional, exterior rendering 73 of the custom designed binder using the active file and (ii) a pair of graphical user interface (“GUI”) controls 75-1 and 75-2 in the form of directional arrows that enable the user to rotate the three-dimensional rendering 73 about its longitudinal or vertical axis in the left and right directions, respectively. In this manner, the software application 23 provides the user with an accurate, three-dimensional, electronic depiction of how the active file will appear when printed on the exterior of the binder.

Program 23 additionally provides on screen display 71 both (i) a drop-down window 77 for selecting the inside color of the binder (e.g., black, white, etc.) and (ii) ring style control buttons 79-1 and 79-2 for selecting the ring style to be utilized in the custom binder order. To assist the user in selecting a particular ring style, a ring style information window 81 is provided which displays pertinent information relating to each style ring (e.g., sheet capacity), the information for each ring style being displayed by positioning the cursor directly on its corresponding ring style control button 79.

If the user is unsatisfied with any aspect of the custom design, additional editing of the active file can be accomplished by clicking upon, and thereby re-opening, create tab 27-3. To the contrary, if the user is satisfied with the design, a check out button 83 on finalize tab 27-5 is activated which, in turn, prepares all of the custom design information for transmittal to product manufacturer 13. Specifically, upon activation of check out button 83, the active file is converted into a print-ready file format that enables manufacturer 13 to execute the custom print order in a simplified manner. With the file prepared for printing, the user is directed to a separate website where, among other things, billing information is formalized in conjunction with execution of the print order.

As will be described in detail below, the software application 23 is provided with a plurality of novel tools that serve to dramatically assist the user in the design process. Specifically, the software application 23 is provided with (i) a panel selection tool, (ii) an image size optimization tool and (iii) a text merge tool, the particulars of each tool to be described in detail below.

### Panel Selection Tool

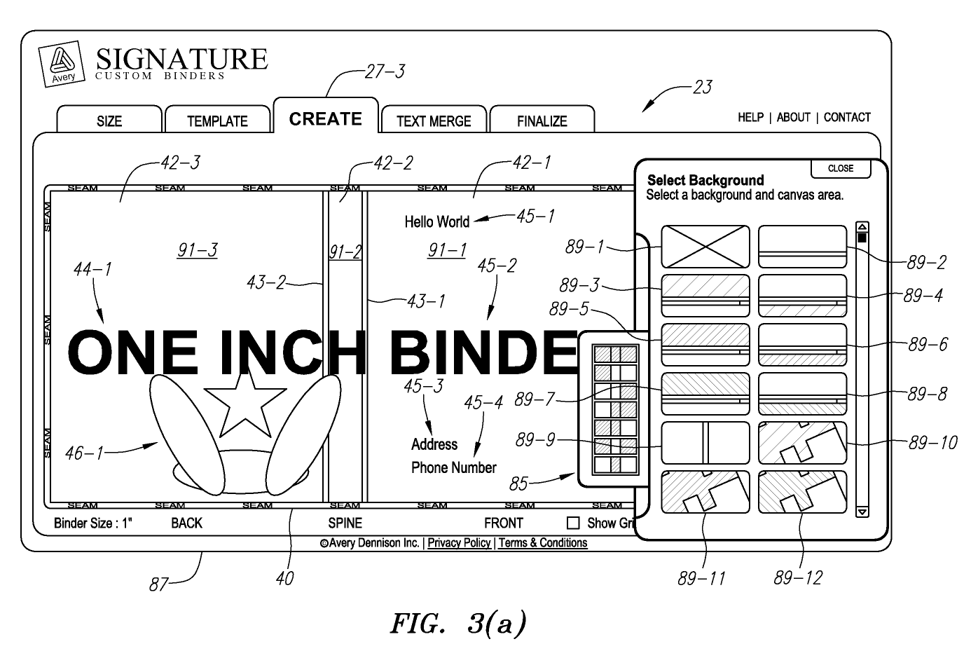

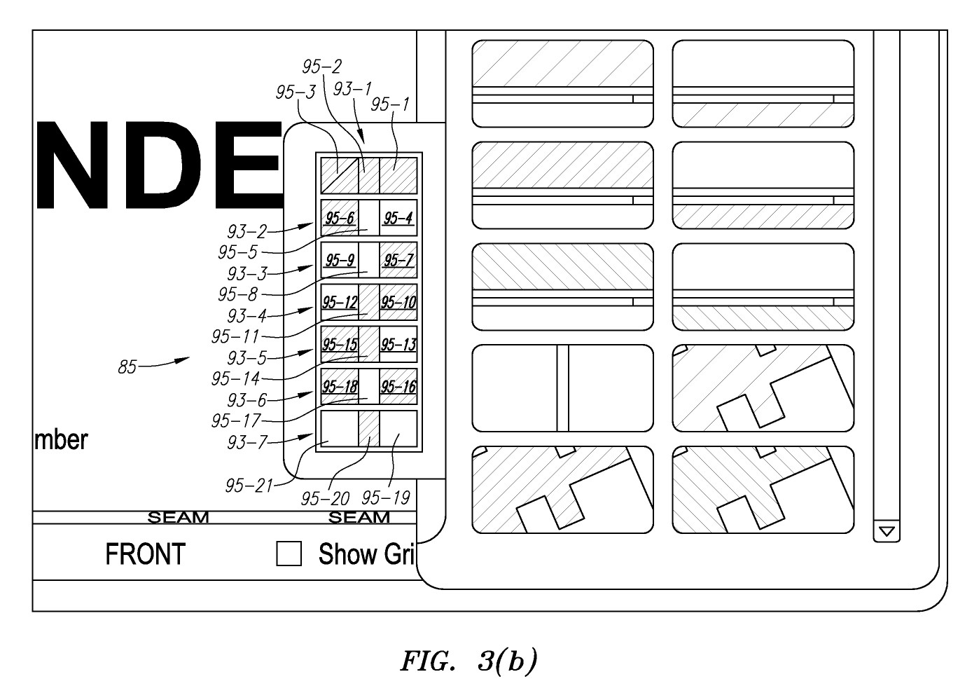

Referring now to FIGS. 3(a)-(b), there is shown a pair of sample screen displays that are useful in understanding the functionality of a panel selection tool 85. In addition, it should be noted that the particulars of panel selection tool 85 are also set forth in co-pending, commonly-assigned, patent application Ser. No. 12/255,630, filed Oct. 21, 2008 in the name of Darren MacDonald, the disclosure of which is incorporated herein by reference in its entirety.

As will be described further below, the software application 23 partitions any visual element (e.g., text element 45-2) that extends across multiple panels 42 of the active workspace 40 into a plurality of discrete subsections, the software application 23 partitioning the visual element through the one or more partition lines 43 that separate the multiple panels 42. Additionally, the multiple panels can be non-adjacent, with an intervening blank or unused panel disposed therebetween. When a visual element that extends across multiple panels is selected, the panel selection tool 85 is automatically activated to enable the user to readily control the display of any combination of the subsections of the visual element within the workspace 40.

Specifically, as shown in FIG. 3(a), there is shown a sample screen display 87 of the active file shown in FIG. 2(e), the screen display 87 being shown with the create tab 27-3 opened and with the background button 55-10 (seen most clearly in FIG. 2(e)) selected. As can be seen in FIG. 3(a), the selection of the background button 55-10 retrieves an array of alternative background patterns 89-1 through 89-12, which are available for selection. In addition, the selection of the background button 55-10 activates the panel selection tool 85, the function of which will be described further in detail below.

The active background element 44-1 extends across multiple panels 42. Accordingly, the software application 23 partitions the background element 44-1 through partition lines 43-1 and 43-2 and into a plurality of discrete subsections 91-1, 91-2, and 91-3. As can be appreciated, subsection 91-1 corresponds to the portion of the background element 44-1 displayed in the front panel 42-1 of the workspace 40, subsection 91-2 corresponds to the portion of the background element 44-1 displayed in the spine panel 42-2 of the workspace 40, and subsection 91-3 corresponds to the portion of the background element 44-1 displayed in the back panel 42-3 of the workspace 40.

As noted above, selection of the background button 55-10 activates the panel selection tool 85. As can be seen, the panel selection tool 85 is represented herein as a graphical user interface (“GUI”) control that automatically pops-up on the workspace 40, the GUI control being in the form of a grid, or table, of uniquely patterned rows 93 (see FIG. 3(b)).

In FIG. 3(b), the panel selection tool 85 shown in FIG. 3(a) is enlarged for greater ease in viewing. As can be seen, each row 93 of the panel selection tool 85 is displayed as a rectangular box that is partitioned into three distinct subsections so as to closely resemble the formatting attributes (i.e., the panels 42) of the active workspace 40 in miniaturized form, the individual subsections being identified herein by reference numerals 95-1 through 95-21.

Each subsection 95 in each row 93 is represented either as shaded or white. If the subsection 95 of a row 93 is represented as shaded, it is to be understood that the particular subsection of the background element 44-1 that is present within the corresponding panel 42 of the workspace 40 is to be displayed. To the contrary, if the subsection 95 of a row 93 is represented as white, it is to be understood that the particular subsection of the background element 44-1 that is present within the corresponding panel 42 of the workspace 40 is not to be displayed with the remainder of the panel(s) 42.

As can be appreciated, the subsections 95 of each row 93 are uniquely shaded in every conceivable combination. In this manner, the user can easily control the display of a visual element within certain panels 42 of the workspace 40 by clicking on a particular row 93 of the panel selection tool 85.

Specifically, in the present example, the panel selection tool 85 includes (i) a first row 93-1 that is patterned to display the background element 44-1 within all panels 42 of the workspace 40 (as shown in FIG. 3(a)), (ii) a second row 93-2 that is patterned to display the background element 44-1 only within the rear panel 42-3 of the workspace 40, (iii) a third row 93-3 that is patterned to display the background element 44-1 only within the front panel 42-1 of the workspace 40, (iv) a fourth row 93-4 that is patterned to display the background element 44-1 only within the front panel 42-1 and the spine panel 42-2 of the workspace 40, (v) a fifth row 93-5 that is patterned to display the background element 44-1 only within the spine panel 42-2 and the rear panel 42-3 of the workspace 40, (vi) a sixth row 93-6 that is patterned to display the background element 44-1 only within the front panel 42-1 and the rear panel 42-3 of the workspace 40, and (vii) a seventh row 93-7 that is patterned to display the background element 44-1 only within the spine panel 42-2 of the workspace 40.

It should be noted that the panel selection tool 85 is not limited to the particular number and pattern of subsections 95 and/or rows 93 shown herein. Rather, it is to be understood that the number and pattern of subsections 95 and/or rows 93 could be modified as deemed necessary without departing from the spirit of the present invention. For example, a workspace with only two panels or an element that extends across only two panels would only require a panel selection tool with three uniquely patterned rows to simulate the various panel selection combinations.

It should also be noted that the panel selection tool 85 is not limited to use in conjunction with the background element 44-1. Rather, it is to be understood that the panel selection tool is designed to similarly activate when a selected text element 45 or image element 46 extends across multiple panels 42 of the workspace 40.

Further, it should be noted that alternative methods of indicating that a particular subsection of the background element 44-1 present within the corresponding panel 42 of the workspace 40 is to be displayed can be employed. For example, each subset of the background element 44-1 can be shown as a thumbnail within each subsection 95 of row 93 that is to be displayed.

### Image Size Optimization Tool

As noted briefly above, software application 23 is designed with an image size optimization tool that ensures the resolution of each image element 46 on the active workspace 40 is maintained above a particular standard. The basic operation of the image size optimization tool is set forth in detail below. In addition, it should be noted that the particulars of the image size optimization tool are also set forth in co-pending, commonly-assigned, patent application Ser. No. 12/255,630, filed Oct. 21, 2008 in the name of Darren MacDonald, the disclosure of which is incorporated herein by reference in its entirety.

Specifically, referring back to the sample screen display 52 shown in FIG. 2(h), the selection of image element 46-2 on the workspace 40 activates a visible picture box 53-1 around the image element 46-2 along with a plurality of image-related controls including, but not limited to, an image resizing tool 53-2, an image rotation tool 53-3 and an image order tool 53-4 (i.e., for moving the image box forward or backward in relation to other elements).

It is to be understood that by clicking on the image resizing tool 53-2, the user is able to resize the image element 46-2 using a fixed aspect ratio. Specifically, while maintaining a click-and-hold action on the image resizing tool, moving the cursor away from the center of the picture causes the image element 46-2 to incrementally increase in size and moving the cursor in towards the center of the picture causes the image element 46-2 to incrementally decrease in size.

It should be noted that certain image elements 46 may appear to be of a satisfactory resolution when depicted on the active workspace 40. However, it has been found that when the image elements 46 are actually printed onto office products, the resolution of the image elements 46 falls beneath an acceptable threshold.

Accordingly, the image size optimization tool of the present invention monitors the resolution of each image element 46 displayed on the workspace 40 and compares the resolution against a predefined resolution threshold of approximately 180 dots per square inch (“dpi”). If the resolution of an image element 46 displayed on the workspace 40 is less than the predefined threshold of 180 dots per square inch, a warning box preferably pops-up on the workspace 40 that notifies the user that the image element 46 is presently oversized. In this manner, the user is ensured that all image elements 46 in the active file will print at an acceptable level, which is highly desirable.

It should be noted that the image size optimization tool is not limited to the use of a resolution threshold of approximately 180 dpi. Rather, it is to be understood that the resolution threshold utilized by the image size optimization tool could be increased or decreased without departing from the spirit of the present invention.

### Text Merge Tool

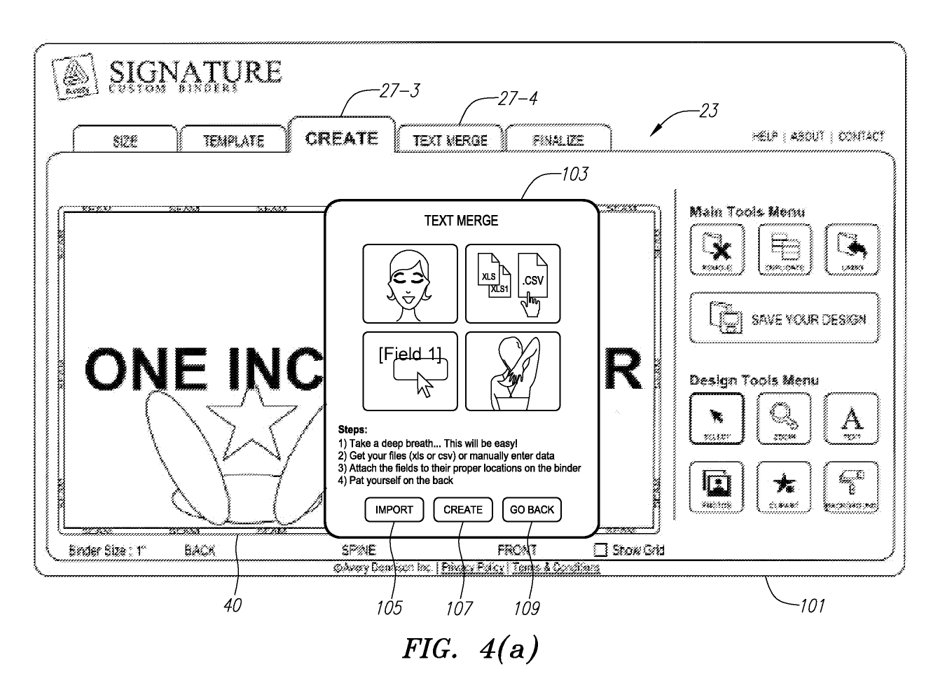

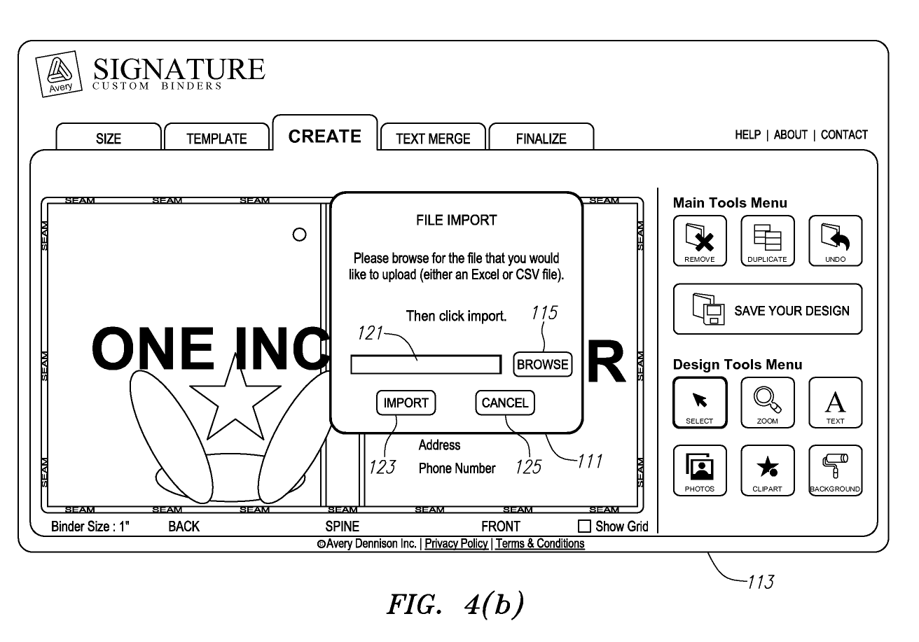

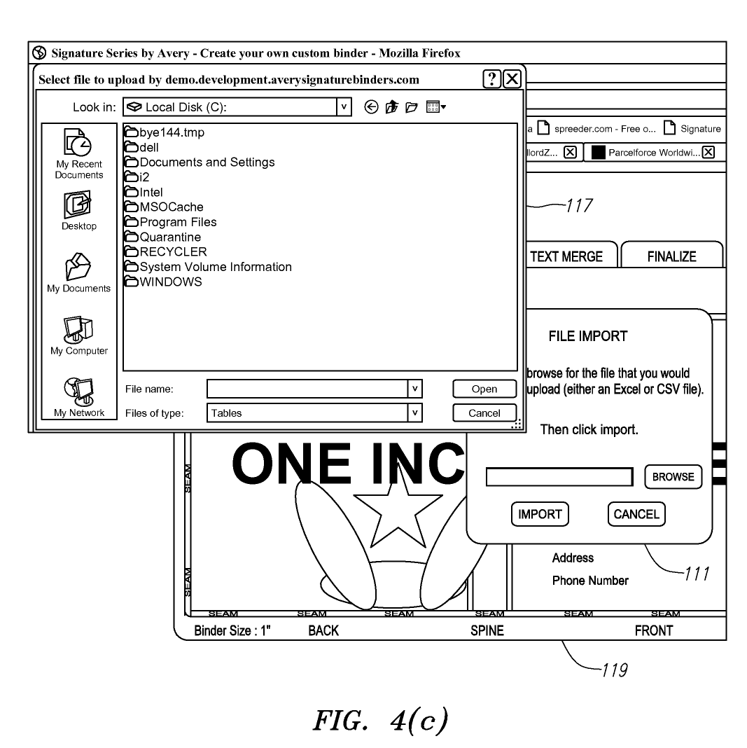

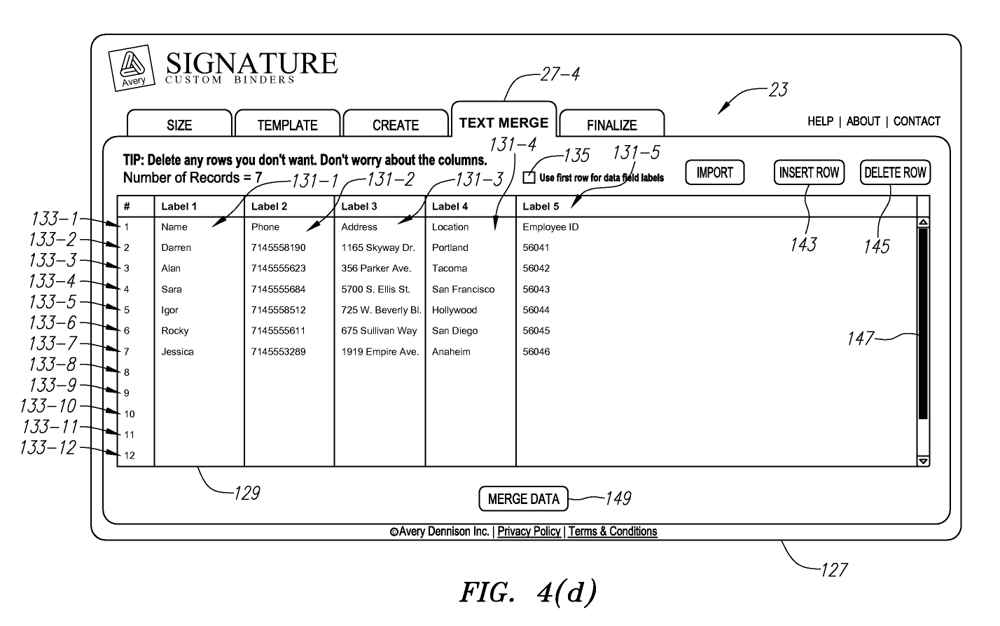

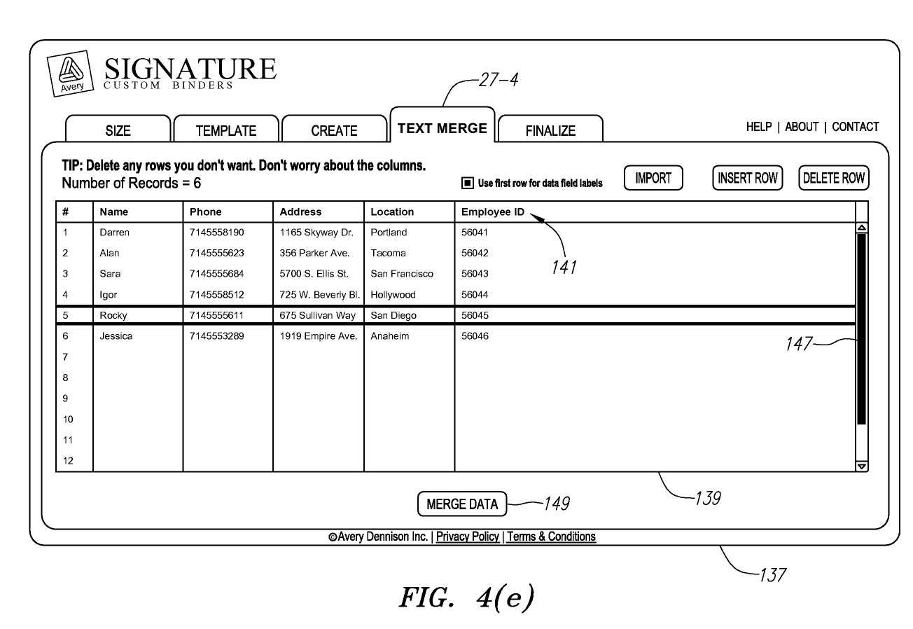

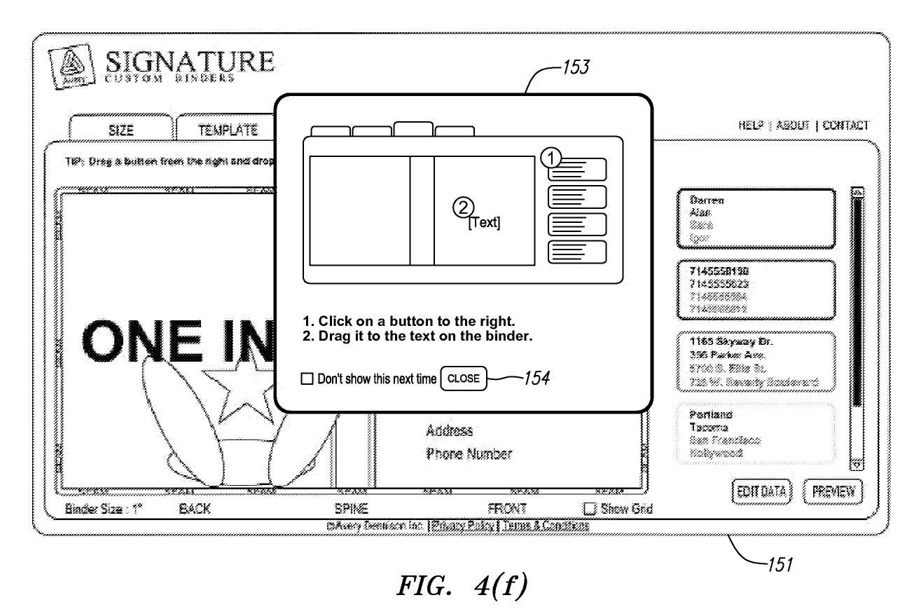

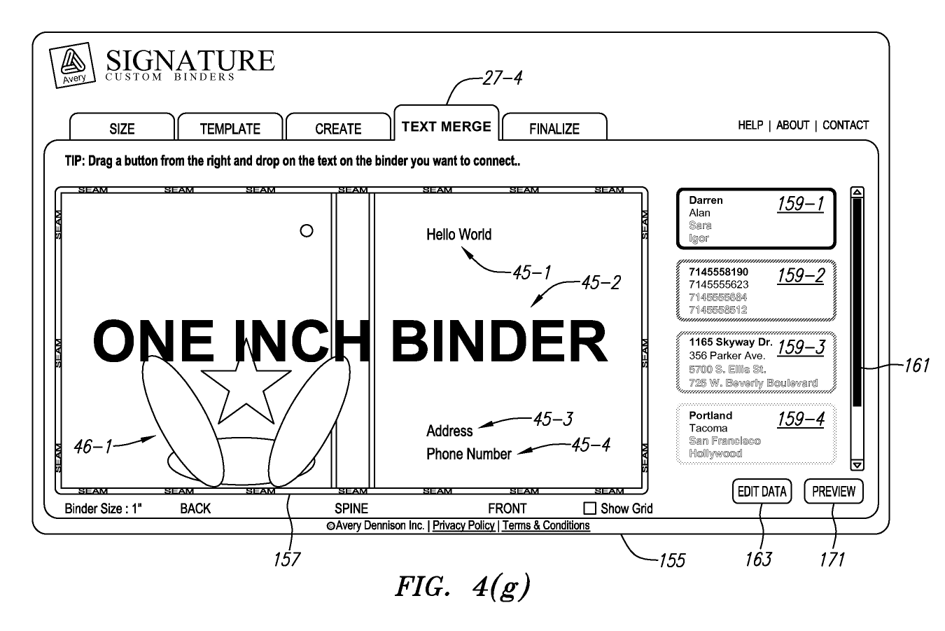

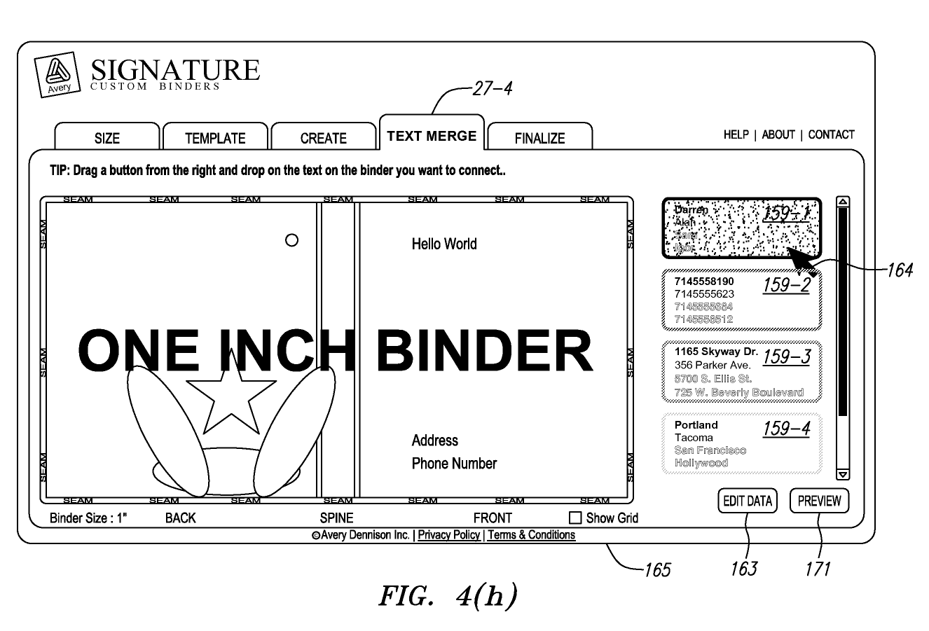

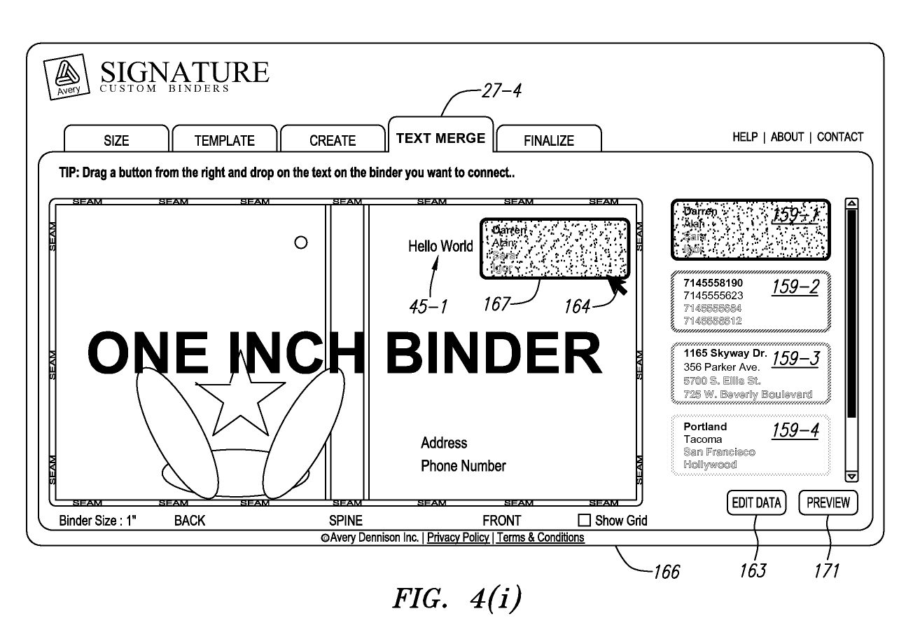

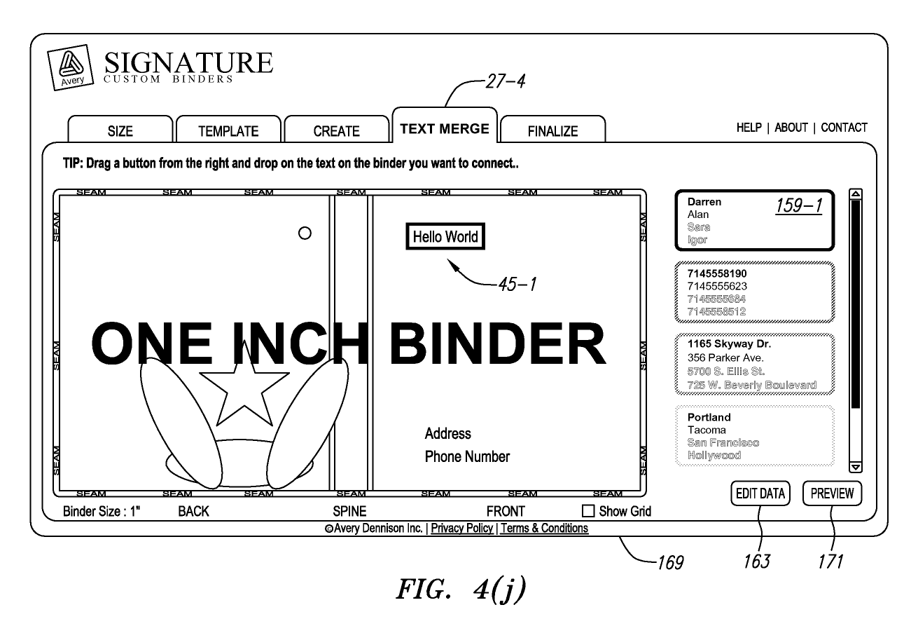

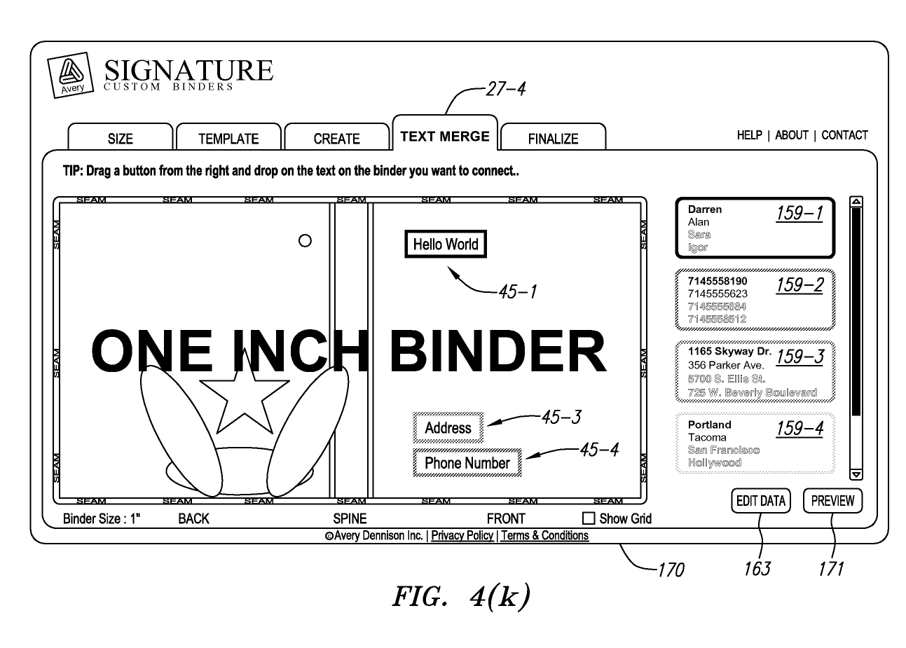

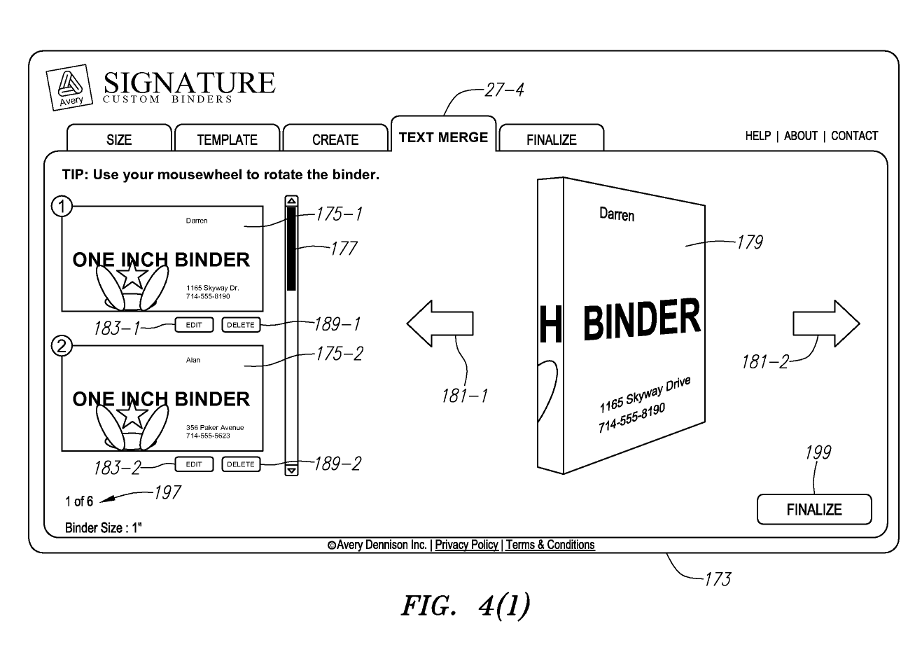

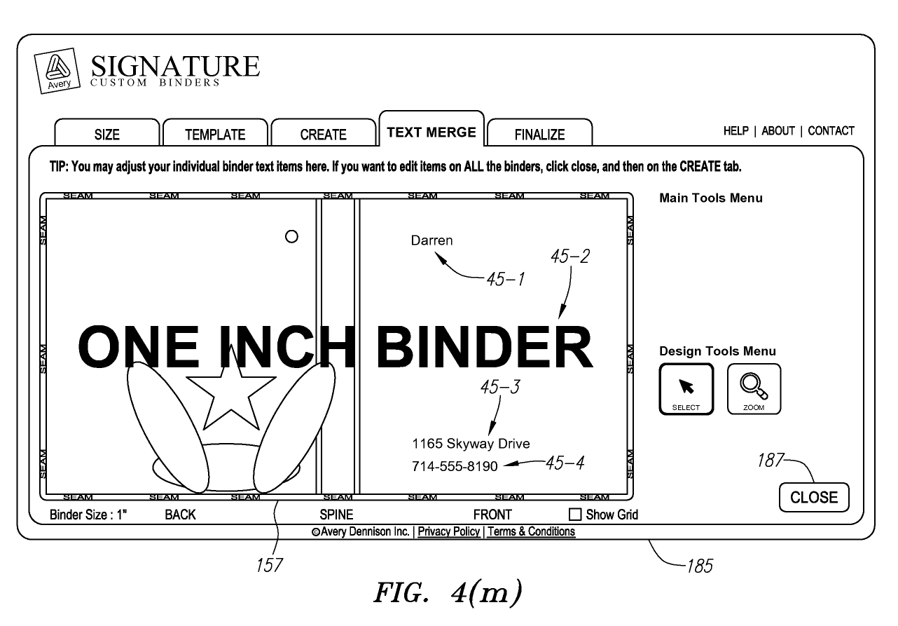

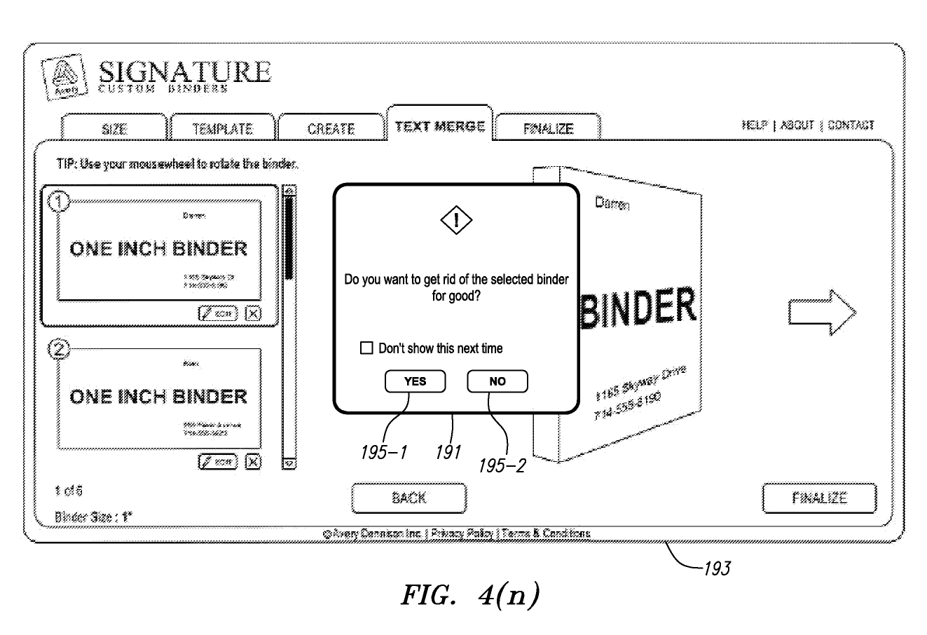

Referring now to FIGS. 4(a) through 4(n), there is shown a series of sample screen displays that are useful in understanding the operation of the text merge tool of the present invention. As will be described further below, the text merge tool enables each text element 45 in the active file to be merged with variable data in order to personalize (i.e., individualize) each customized binder generated in conjunction with the print order.

Preferably, with create tab 27-3 opened so as to display the active file on workspace 40, the text merge tool is initiated by the user by activating text merge tab 27-4. As shown in the sample screen display 101 represented in FIG. 4(a), clicking on text merge tab 27-4 results in the activation of a selection dialog pop-up box 103 that provides a simplified illustrative overview of the text merge process. In addition, selection dialog box 103 queries the user whether the dataset to be utilized in the text merge is to be (i) imported from an external source (e.g., a database or a file) or (ii) created using software application 23. To assist in the selection process, selection dialog box 103 includes an import button 105, a create button 107 and a go back button 109 (the activation of go back button 109 terminating the text merge process and returning the user to opened create tab 27-3).

It should be noted that with selection dialog box 103 displayed in the foreground, the remaining visual elements, which are displayed in the background of screen display 101, appear slightly out of focus, or blurred, to draw the attention of the user to selection dialog box 103.

To import a file for the text merge, import button 105 is activated by the user. In response thereto, selection dialog box 103 is replaced by a file import dialog box 111, as shown in the sample screen display 113 represented in FIG. 4(b). It should be noted that with file import dialog box 111 displayed in the foreground, the remaining visual elements, which are displayed in the background of screen display 113, can appear slightly out of focus, or blurred, to draw the attention of the user to file import dialog box 111.

To locate the desired dataset file, the user is required to click upon a browse button 115 that is provided in file import dialog box 111. Activation of browse button 115, in turn, opens a pop-up window 117 in front of file import dialog box 111, as shown in the sample screen display 119 represented in FIG. 4(c). As can be seen, pop-up window 117 displays the files that are accessible by the active customer computer 21. Referring back to FIG. 4(b), once the desired file is selected by the user, the file is, in turn, displayed in a file window 121 in file import dialog box 111. Alternatively, the user can directly enter the file name into the file window 121. Upon confirming that the proper file is displayed in window 121, the user clicks on an import button 123 to upload the file into application 23. It should be noted that a cancel button 125 is also provided in file import dialog box 111 to terminate the file importation process.

It should be noted that, to facilitate integration of the file into application 23, it is preferred that the uploaded file be represented in either a standard Comma Separated Values file format (.csv) or in a MICROSOFT EXCEL file format (.xlsx, .xls). MICROSOFT and EXCEL are registered trademarks of Microsoft Corporation of Redmond, Wash. However, it is to be understood that application 23 could be modified to accept alternative types of spreadsheet-style file formats without departing from the spirit of the present invention.

If the user prefers to create the dataset to be used in the text merge operation using application 23, create button 107 on the selection dialog box 103 shown in FIG. 4(a) is activated by the user.

Upon completion of either of the aforementioned import or create sub-processes, software application 23 opens text merge tab 27-4. Referring now to FIG. 4(d), there is shown a sample screen display 127 that is generated by application 23 when text merge tab 27-4 is opened. As can be seen, text merge tab 27-4 includes an enlarged data grid 129. In the present example, an imported file is used for the text merge. Accordingly, the dataset provided from the imported file is displayed in data grid 129 in tabular form. Although not shown herein, it is to be understood that if the collection of data to be used for the text merge is to be created using application 23, a similar style data grid would be generated that includes a plurality of blank cells.

Data grid 129 is arranged into a plurality of columns 131-1 through 131-5 and rows 133-1 through 133-12 that organize the imported or user-generated variable data to be used in the text merge. The information, i.e., variable data, displayed in each cell of the data grid 129 can be manually input and/or edited by the user by either clicking directly upon the cell, tabbing horizontally through the grid, moving vertically down through the grid using the enter/return key, or navigating through the grid using keyboard arrow keys and, in turn, typing the desired content.

Preferably, the variable data provided in data grid 129 is grouped into a plurality of common data fields, with each column 131 representing a particular data field. As defined herein, the term “data field” represents a particular type, or category, of variable data to be used in the text merge (e.g., the name, phone number, address, location or identification number of an individual). If the dataset used to fill in the data grid 129 is imported from a pre-existing spreadsheet file, the number of data-filled columns 131 displayed in data grid 129 reflects the number of data fields that is present in the imported file.

Similarly, the variable data provided in data grid 129 is grouped into a plurality of common records, with each row 133 representing a particular record. As defined herein, the term “record” represents a row in data grid 129, each row having a collection of variable data assigned thereto that relates to the various data fields provided in data grid 129. For example, each record may correspond to a particular individual or entity that is to receive a personalized binder in conjunction with the order. In this manner, it is to be understood that the number of customized binders to be ultimately produced in the binder order should directly correspond to the number of records provided in data grid 129.

It should be noted that data grid 129 is not limited to grouping common data fields into columns and individual records into rows. Rather, it is to be understood that data grid 129 could be reconfigured in reverse (i.e., by grouping common data fields into rows and individual records into columns) without departing from the spirit of the present invention.

To assist the user in the review of data grid 129, application 23 is configured by default to display the first row 133-1 of data grid 129 as a plurality of data field labels rather than the variable data associated with a particular record. For example, in FIG. 4(d), first row 133-1 of data grid 95 displays the data field labels “Name”, “Phone”, “Address”, “Location”, and “Employee ID” in place of the variable data associated with a particular record. However, a data field label box 135 is provided that enables the user to reconfigure this setting (i.e., between either a “display label” setting or a “hide label” setting). Specifically, referring now to FIG. 4(e), there is shown a sample screen display 137 that depicts a data grid 139 similar to data grid 129 in FIG. 4(d) but with data field label box 135 activated. As can be seen, activation of data field label box 135 rolls the first row of data field labels shown in first row 133-1 of data grid 129 up into the header row 141 for data grid 139 (the variable data provided within the other rows 133 of data grid 129 similarly moving up one row).

Referring back to FIG. 4(d), if an additional row 133 is required for data grid 129 (e.g., to accommodate additional records), an insert row button 143 on text merge tab 27-4 is activated. Similarly, if a particular row 133 is to be removed from data grid 129 (e.g., to prevent an individual from being included in the custom binder order or to remove a row that does not include any variable data), the row 133 is first selected by the user and then a delete row button 145 on text merge tab 27-4 is activated.

Preferably, application 23 is configured to support a wide range in the number of rows 133. To facilitate review of data grid 129, a vertical scroll bar 147 is provided to assist in the location of a particular row 133 in grid 129.

Once data grid 129 accurately reflects the desired data to be utilized in the text merge, a merge data button 149 on the bottom of the text merge tab 27-4 is activated by the user. In turn, software application 23 generates a first highly intuitive graphical user interface to facilitate the process of binding the variable data associated with a data field (e.g., the variable data provided in a column 131 of data grid 129) to a corresponding text element 45 in the active file. Specifically, referring now to FIG. 4(f), there is shown a sample screen display 151 that is generated by application 23 to assist in the completion of the text merge process. As can be seen, a pop-up window 153 is initially displayed in the foreground that provides a simplified overview of the binding process, the background being shown slightly blurred to direct attention to the information provided in window 153. Upon closing window 153 by clicking a close button 154, the screen display shown in FIG. 4(g) remains, the screen display being identified generally by reference numeral 155.

As seen in the screen display 155 shown in FIG. 4(g), the first graphical user interface generated by software application 23 in response to the text merge request includes a limited functionality workspace, or canvas, 157 and an array of data field buttons 159-1 through 159-4. Workspace 157 is in the form of an enlarged two-dimensional depiction of the active file to be used in conjunction with the custom print order. However, it should be noted that application 23 precludes the user from editing the active file shown on workspace 157 in any way other than to bind data fields to corresponding text elements 45. The user is not permitted to otherwise modify the active file (e.g., by changing the size, font, color, and/or relative position of text elements 45) on workspace 157 until the text merge process is completed, as will be described further below.

Software application 23 partitions the variable data in grid 129 by its various data fields (i.e., by separating the data provided in each column 131) and, in turn, assigns the variable data associated with each data field to a corresponding data field button 159. As can be seen, the array of data field buttons 159 extends vertically along the right side of screen display 155 and is arranged top-to-bottom in the sequence from left-to-right as listed on data grid 129. To assist in the location of a particular data field button 159 within the array, a vertical scroll bar 161 is provided.

As can be seen, the variable data associated with the first few records of each data field in grid 129 is displayed inside of a corresponding field button 159. In this manner, the user can readily ascertain the data field category linked with each field button 159. It should be noted that the information, i.e., variable data, provided inside of each field button 159 is represented in a standard font and is not directly modifiable by the user. If the user desires to edit the variable data associated with a particular data field, an edit data button 163 is activated at the bottom of screen 155 that returns the user to the data grid screen 137 shown in FIG. 4(e).

As seen in FIG. 4(g), each field button 159 is preferably provided with uniquely colored periphery, or border, for reasons to become apparent below. For example, first data field button 159-1 can be provided with a first colored border, second data field button 159-2 can be provided with an second colored border, third data field button 159-3 can be provided with a third colored border and fourth data field button 159-4 can be provided with a fourth colored border. The interior of each data field button is preferably provided with a common fill color (e.g., gray).

To bind, or link, the variable data associated with a particular data field in data grid 129 to a specific text element 45 shown in workspace 157, the user is first required to select the corresponding data field button 159 from the array. Specifically, as seen most clearly in FIG. 4(h), there is shown a sample screen display 165 that displays the cursor 164 positioned directly above first data field button 159-1. With the cursor 164 positioned above the data field button 159-1, its corresponding border color fills throughout the entirety of the data field button 159-1. Referring additionally to the sample screen display 166 shown in FIG. 4(i), selection of the field button 159-1 by any suitable manner (e.g., using a click-and-hold action) causes application 23 to generate a small, rectangular box-shaped icon 167 that corresponds in color to the border color associated with its field button 159-1. The miniature, color-coded icon 167, in turn, can be dragged by the user into workspace 157. As can be appreciated, icon 167 denotes that the collection of variable data associated with data field button 159-1 has been selected and is ready to be bound to a particular text element 45 in workspace 157.

To bind, or merge, the variable data associated with data field button 159-1 to the active file, the user positions icon 167 directly above a particular text element 45-1 in workspace 157. Referring additionally to FIG. 4(j), it should be noted that a similar color-coded border, or frame, is generated around the particular text element 45-1 as icon 167 visually overlies at least a portion of the text element 45-1. The user can then readily select the identified text element 45 for data binding by any suitable manner. For example, the binding process can be accomplished either by (i) using a drag-and-drop action with the desired data field button 159, (ii) sequentially clicking first a data field button 159 and then the desired text element 45 or (iii) any other suitable method. Once completed, the variable data associated with the selected data field button 159-1 is effectively bound to the selected text element 45-1.

To intuitively notify the user of the successful merge, a common graphical marking is displayed for a text element 45-1 and for the selected data field button 159-1, as shown in the sample screen display 169 provided in FIG. 4(j). For illustrative purposes only, color-coded borders are utilized herein as the common graphical markings applied to bound pairs of data field buttons 159 and text elements 45. Specifically, the unique border color associated with the selected data field button 159-1 is permanently displayed around the text element 45-1 to which it is bound. Accordingly, through the use of the various color-coded borders, the user is able to readily ascertain which data field button 159 has been merged with a text element 45. For example, as depicted in the sample screen display 170 shown in FIG. 4(k), the unique color-coded border provided around data field button 159-1 is similarly applied to corresponding text element 45-1, the unique color-coded border provided around data field button 159-2 is similarly applied to text element 45-4 and the unique color-coded border provided around data field button 159-3 is similarly applied to text element 45-3 to denote merged items.

It should be noted that present invention is not limited to the use of color-coded borders as common graphical markings. Rather, it is to be understood that other types of common graphical markings could be utilized in place of color-coded borders without departing from the spirit of the present invention. In fact, it is to be understood that any visual manner of intuitively linking a bound text element 45 with its corresponding data field button 159 falls within the scope of the present invention. For instance, in place of common graphical markings, the text of a bound text element 45 may be modified to display the data field label, or category, of its associated data field button 159. Alternatively, a record of the data field can be bound to text element 45.

It should also be known that a single data field button 159 may be bound to more than one text element 45 on workspace 157. In this situation, the common graphical marking associated with the data field button 159 (e.g., a color-coded border) would be similarly applied to each of the bound text elements 45.

If the user wishes to undo the aforementioned binding process, an unbinding action can be undertaken by the user. For example, a data field button 159 and its associated variable data may be unbound from a text element 45 by either (i) double-clicking on the bound text element 45, (ii) clicking on the bound text element 45 and dragging the box-shaped icon 167 which is generated in response thereto away from the bound text element 45, or (iii) binding a second data field button 159-2 to the bound text element 45 which, in turn, replaces the merge with the first data field button 159-1 bound thereto (i.e., each text element 45 can only be bound to one data field button 159 at a time)

The aforementioned binding process can be repeated as deemed necessary for one or more field buttons 159 provided in the array. Once completed, the user is required to activate a preview button 171 located at the bottom of the text merge tab 27-4. In turn, application 23 generates a text merge preview screen that is represented in the form of a second highly intuitive graphical user interface, a sample screen display of the text merge preview screen being shown in FIG. 4(l) and identified generally by reference numeral 173.

As can be seen, text merge preview screen 173 includes a vertical array of binder thumbnails 175-1 through 175-2, each thumbnail 175 representing a distinct artwork print file corresponding to a specific binder to be printed in conjunction with the order. Accordingly, each thumbnail 175 includes the unique variable data assigned thereto as a result of the above-described text merge. A vertical scroll bar 177 is provided beside the array of thumbnails 175 to assist in scanning through the entirety of the custom binder set.

An enlarged, three-dimensional rendering, or preview, 179 of the first thumbnail 175-1 in the array is displayed on screen display 173. To modify rendering 179 to display the variable data associated with another binder provided in the array, the thumbnail 175 for said binder can be selected by the user (e.g., by double-clicking on the thumbnail). In this manner, the user is provided with the capability to review each binder to be produced as part of the custom print order.

A pair of GUI controls 181-1 and 181-2 in the form directional arrows are also provided that enable the enlarged preview 179 to be rotated about its longitudinal or vertical axis in the left and right directions, respectively. In this manner, the user is able view binder preview 179 from various angles to ensure satisfaction. If the variable data provided on the binder preview 179 introduces an undesirable result (e.g., if a long surname causes a text element 45 to extend beyond a seam of the binder), the user can modify aspects of said text element 45 by clicking on an edit button 183 provided directly below its corresponding thumbnail 175 (edit buttons 183-1 and 183-2 being shown directly beneath thumbnails 175-1 and 175-2, respectively).

Upon clicking on edit button 183, a binder edit screen is generated, a sample screen display of the binder edit screen being shown in FIG. 4(m) and identified generally by reference numeral 185. With binder edit screen 185 opened, the user is able to modify selected aspects of a bound text element 45 (e.g., text element 45-1) by clicking directly upon said element. Specifically, once selected, each text element 45 can be stretched, rotated, and/or moved within the workspace canvas 157. However, it should be noted that only text elements 45 in the active file are capable of modification by the user from this screen display 185. Other elements (e.g., background elements, image elements, etc.) are incapable of modification by the user from this screen, but can be modified as described previously. It should also be noted that all modifications made to a particular text element 45 are implemented with respect to the active binder only (i.e., the remaining binders in the order remain unchanged). Once satisfied with the required edits, the user can return to text merge preview screen 173 by clicking on a close button 187 at the bottom of screen 185.

Referring back to FIG. 4(l), delete buttons 189-1 and 189-2 are provided directly beneath thumbnails 175-1 and 175-2, respectively. If the user wishes to eliminate a particular binder from the order, its corresponding delete button 189 is activated.

In response to the delete request, a delete confirmation pop-up window 191 is automatically generated in the foreground, as represented in the sample screen display 193 shown in FIG. 4(n). As can be seen, delete confirmation pop-up window 191 requests that the user confirm deletion of the selected binder using “yes” and “no” confirmation buttons 195-1 and 195-2, respectively, the background appearing slightly blurred to draw the attention of the user to window 191. If the user opts to positively confirm deletion (i.e., by clicking on button 195-1), the selected binder is removed from the array of thumbnails 175 on screen 137.

Referring back to FIG. 4(l), a counter 197 is preferably provided at the bottom of screen 173 to indicate the current number of binders in the order which, for example, can be determined by counting the number of records shown in FIG. 4(e) Preferably, if the number of counted binders exceeds a pre-defined threshold, application 23 is designed to include one or more additional steps. For example, a large binder order (e.g., in excess of 100) may trigger application 23 to generate a pop-up window that notifies the user that larger orders may result in a small production delay.

Once satisfied, the user completes the text merge process by clicking on a finalize button 199 on the bottom text merge preview screen 173. In response thereto, application 23 opens up finalize tab 27-5 (see FIG. 2(j)). In this manner, the custom binder order can be completed and, in turn, transmitted to print facility 22 for execution.

The embodiments shown in the present invention are intended to be merely exemplary and those skilled in the art shall be able to make numerous variations and modifications to them without departing from the spirit of the present invention. For example, in the case of a customized binder, the customization can be done on the outside surface of the binder, the inside surface of the binder or on both the inside and outside surfaces of the binder. All such variations and modifications are intended to be within the scope of the present invention as defined in the appended claims.

What is claimed is:

1. A method of creating at least one electronic print file to be used in the customized design of at least one printable office product, the method being implemented using a software application, the method comprising the steps of:
(a) providing a design file that is formatted for each of the at least one printable office product, the design file including a first text element,
(b) inputting at least one variable datum using the software application, the at least one variable datum included in a first data field, and
(c) using the design file and merging the first data field with the first text element to yield at least one individualized print file.

2. The method as claimed in claim 1 wherein, in the input step, the at least one variable datum is input into the software application by importing a dataset file from an external source.

3. The method as claimed in claim 1 wherein, in the input step, the at least one variable datum is created using the software application.

4. The method as claimed in claim 1 wherein, in the input step, the software application displays the at least one variable datum within a data grid.

5. The method as claimed in claim 4 wherein the at least one variable datum displayed within the data grid is modifiable.

6. The method as claimed in claim 5 wherein the data grid is arranged into at least one column and at least one row, each column being designated for a particular data field and each row being designated for a particular record.

7. The method as claimed in claim 6 wherein the number of rows displayed in the data grid is modifiable.

8. The method as claimed in claim 1 wherein, in the merging step, the software application generates a graphical user interface to facilitate merging the first data field with the first text element.

9. The method as claimed in claim 8 wherein the graphical user interface comprises:
(a) a workspace displaying the design file with the first text element, and
(b) a first data field button corresponding to the first data field.

10. The method as claimed in claim 9 wherein, in the merging step, the at least one variable datum associated with the first data field is bound to the first text element in the workspace.

11. The method as claimed in claim 10 wherein, after being bound, the first data field button and the first text element are each provided with a common graphical marking.

12. The method as claimed in claim 11 wherein, the common graphical marking is color-coded.

13. The method as claimed in claim 11 wherein the graphical user interface further comprises a second data field button corresponding to a second data field in the at least one variable datum, the second data field button being displayed with a different graphical marking than the first data field button.

14. The method as claimed in claim 1 further comprising the step of, after the merging step, reviewing the at least one individualized print file.

15. The method as claimed in claim 14 wherein, in the review step, the at least one individualized print file is represented in a graphical user interface as a thumbnail image displaying the at least one variable datum.

16. The method as claimed in claim 15 wherein the thumbnail image is viewable within the graphical user interface as an enlarged three-dimensional rendering.

17. A method of manufacturing at least one printable office product, the method implemented using a software application, the method comprising the steps of:
(a) providing a design file that is formatted for the at least one printable office product, the design file including a first text element,
(b) inputting at least one variable datum using the software application, the at least one variable datum included in a first data field, and
(c) using the design file and merging the first data field with the first text element to yield at least one individualized print file.

18. The method as claimed in claim 17 further comprising the step of, after the merging step, printing the at least one individualized print file on a corresponding at least one printable office product.

19. A system for the custom design of at least one printed office product, the system comprising:
(a) a server including a computer-readable medium, and
(b) at least one computer electronically linked with the server,
(c) wherein a software application is stored on the computer-readable medium, and the software application is downloadable to the at least one computer, the software application generating at least one electronic print file to be used in the customized design of at least one printable office product, the software application being designed to provide a design file that is formatted for the at least one printable office product, the design file including a first text element, the software application also being designed to receive at least one variable datum, the at least one variable datum included in a first data field, the software application further being designed to use the design file and to merge the first the first data field with the first text element to yield at least one individualized print file.

20. The system as claimed in claim 19 wherein the downloadable software application is configured to run within a browser application on the at least one computer.
